(19) United States
(12) Patent Application Publication
(10) Pub. No.: US 2005/0194414 A1
(43) Pub. Date: Sep. 8, 2005

(54) Cargo container

(76) Inventor: Richard Quentin Lynch, Isle of Palms, SC (US)

Correspondence Address: KATHLEEN M HARLESTON;THE HARLESTON LAW FIRM, 909 TALL PINE ROAD, MT PLEASANT, SC, 29464, US

(21) Appl. No.: 10/794,096

(22) Filed: Mar. 5, 2004

(51) Int. Cl. B60R 9/055; B60R 9/00; B60R 7/00; B60R 11/00

(52) U.S. Cl. 224/401; 224/274; 224/406; 224/328

(57) ABSTRACT

A cargo container attachable to a top of a tee tower of a watercraft, a golf cart, or an all-terrain vehicle, which includes: (a) an upper lid section; (b) a lower section pivotally connected to the lid section, the lower section including a bottom wall and a lip extending generally upwardly from a periphery of the bottom wall; (c) a storage space formed by the upper lid section and the lower section; (d) at least one hinge pivotally connecting the lid section and the lower section; and (e) an attachment mechanism on the bottom wall of the lower section for securing the cargo container to the tee tower, golf cart, or all-terrain vehicle.

### CROSS REFERENCE TO RELATED DOCUMENT

This invention was described in Disclosure Document Number 542299, which was received by the U.S. Patent & Trademark Office on Nov. 24, 2003.

### BACKGROUND OF THE INVENTION

1. Technical Field

The present invention relates to a cargo container for storing goods, more particularly, a cargo container for attachment to a top of a tee tower of a small watercraft, or the top of a golf cart, utility vehicle, or all-terrain vehicle, optionally in place of the top.

2. Background Information

Small watercraft, particularly center console, 14 to 40 feet length overall (L.OA.) watercraft with tee tops, have little enclosed, readily accessible storage space. Storage space on deck for electrical, navigational, and recreational equipment is especially limited. Currently, no easily installable storage units for these types of boats exist, particularly a storage unit that a boat owner can purchase. Even if a suitable storage unit could be found, there is limited space available on board to put it. Thus, there is a need for such a storage unit. The present invention is an easily installed, lightweight marine cargo carrier. Since on board space is limited, the present cargo container is attachable to a top of an existing tee tower of a small watercraft in place of or on top of the tee top.

Golf carts have a storage problem that is somewhat akin to small watercraft. Golf carts are not just for the golf course anymore. They have become increasingly popular as a means for transportation for residents of seaside communities. Golf carts are also abundant at facilities such as airports, military bases, construction sites, factories, warehouses, hospitals, parking garages, motels, hotels, casinos, and resorts where personnel must frequently cover significant distances in relatively short periods of time. These golf cart users often need to transport items, which are sometimes sizable. For example, residents of seaside communities often go to the grocery store in their carts and require space for carrying groceries and other shopping bags. Military personnel often need to carry weapons. Construction workers have to move awkward blueprints and surveying equipment, for example. Motels, hotels, casinos, and resorts often need to transport landscaping materials, decorations, and household goods. However, golf carts have very limited storage space, since they were designed to accommodate golfers and golf clubs for travel about a golf course. Thus, there is a need for an on-board storage unit on a golf cart.

The present invention is an easy to use, lightweight cargo carrier attachable to a top of a golf cart or a similar vehicle, such as a utility cart or an all-terrain vehicle. The cargo container may replace the existing roof or top, or attach to the existing roof or top of the vehicle.

### BRIEF SUMMARY OF THE INVENTION

The present invention is an aerodynamic cargo container for attachment to a top of an existing tee tower of a watercraft or a top of a golf cart or the like, preferably in place of a roof or top. The cargo container comprises: (a) an upper lid section; (b) a lower section pivotally connected to the lid section, the lower section comprising a bottom wall and a lip extending generally upwardly from a periphery of the bottom wall; (c) a storage space formed by the upper lid section and the lower section; (d) at least one hinge pivotally connecting the lid section and the lower section; and (e) an attachment mechanism on the bottom wall of the lower section for securing the cargo container to the tee tower, golf cart, or all-terrain vehicle. Additional preferred components of the cargo container include: a latching mechanism for engaging the lid section with the lower section; a locking mechanism for locking and unlocking the cargo container; louvered vents in the bottom wall for promoting air circulation; and a handle for pulling the lid section down to close the cargo container. The cargo container preferably includes either a rod assembly or a pair of pistons for holding the container open.

An embodiment of the cargo container includes an attachment mechanism for mounting the cargo container to aluminum tubing of a tee tower. Another embodiment of the cargo container for mounting the cargo container on a top of a golf cart or the like includes flanges extending generally downward from the bottom wall. The flanges fasten to roof support struts of the golf cart. Preferably, handles or hand grips and a lower compartment protruding from the lower section enhance the functionality of the cargo container.

The cargo container according to the present invention is useful, for example, on a golf cart for hauling chairs, towels, coolers, radios, and toys to and from the beach, and extra golf accessories around the golf course. Golf carts with the present cargo container can also be used off-course for holding equipment, books, groceries, construction supplies, etc. The cargo container can also be used on a small watercraft with a tee top for storing some or all of a watercraft's electronic systems for easy access and easy servicing. Hunters can use the cargo container, particularly on an all-terrain vehicle, to transport items, such as tents, camping gear, guns, and ammunition. Personnel at golf courses, airports, military bases, factories, warehouses, security units, beach patrol units, hospitals, parking garages, motels, hotels, casinos, and resorts can all use the versatile cargo container of the present invention. Since it is mounted on top of the vehicle or watercraft, the present cargo container, which is lightweight and unobtrusive, does not occupy space within these small vehicles or watercraft.

### BRIEF DESCRIPTION OF THE SEVERAL VIEWS OF THE DRAWINGS

A more complete understanding of the invention and its advantages will be apparent from the following detailed description taken in conjunction with the accompanying drawings, wherein examples of the invention are shown, and wherein:

FIG. 1 is a perspective view of a cargo container according to the present invention, shown in an open position;

FIG. 2 is a perspective view of a rod assembly of a cargo container according to FIG. 1;

FIG. 3 is a front perspective view of a cargo container according to the present invention, shown in a closed position;

FIG. 4 is a rear perspective view of a cargo container according to FIG. 3;

FIG. 5 is a top plan view of a cargo container according to FIG. 3;

FIG. 6 is a side elevational view of a cargo container according to FIG. 3;

FIG. 7 is a bottom plan view of a cargo container according to the present invention;

FIG. 8 is a bottom plan view of an attachment assembly of a cargo container according to the present invention;

FIG. 9 is a perspective view of an attachment assembly of a cargo container according to the present invention;

FIG. 10 is perspective view of an alternative embodiment of a cargo container according to the present invention, shown in an open position;

FIG. 11 is a side elevational view of an alternate embodiment of a cargo container according to the present invention, shown in a closed position and with a hand grip and a lower compartment for a golf cart;

FIG. 12 is a bottom plan view of an alternate embodiment of a cargo container according to FIG. 13;

FIG. 13 is a front elevational view of a lower compartment of a cargo container according to the present invention;

FIG. 14 is a side elevational view of an attachment mechanism of a cargo container according to the present invention, shown attached to a roof strut of a golf cart;

FIG. 15 is a side elevational view of an attachment mechanism of a cargo container according to the present invention, shown attached to a strut of a golf cart;

FIG. 16 is a top plan view of an alternate embodiment of a cargo container according to the present invention, shown with a pair of first handles;

FIG. 17 is a front elevational view of an alternate embodiment of a cargo container according to FIG. 16;

FIG. 18 is a top plan view of an alternate embodiment of a cargo container according to the present invention, shown with a second, elongate handle;

FIG. 19 is a front elevational view of an alternate embodiment of a cargo container according to FIG. 18;

FIG. 20 is a side elevational view of an alternate embodiment of a cargo container according to the present invention;

FIG. 21 is a perspective view of an alternate embodiment of a cargo container according to the present invention, shown in an open position;

FIG. 22 is a bottom plan view of an alternate embodiment of a cargo container according to the present invention; and

FIG. 23 is a side elevational view of a cargo container according to FIG. 22, shown on a tee tower of a boat.

### DETAILED DESCRIPTION OF THE INVENTION

In the following description, like reference characters designate like or corresponding parts throughout the several views. Also, in the following description, it is to be understood that such terms as “front,” “back,” “within,” and the like are words of convenience and are not to be construed as limiting terms. Referring in more detail to the drawings, the invention will now be described.

The present invention is a cargo container, generally referred to by reference number 10, for attachment to the top of a golf cart or all terrain vehicle or the like in place of a roof or top of the cart or vehicle. The utility cart may be gas-powered or powered by electricity. All terrain vehicles include 4×4 or 2×2 ATVs. Alternatively, the cargo container 10 is attachable to an existing tee tower of a small watercraft. By “small watercraft” is meant a center console, 14 to 40 feet length overall (L.OA.) watercraft.

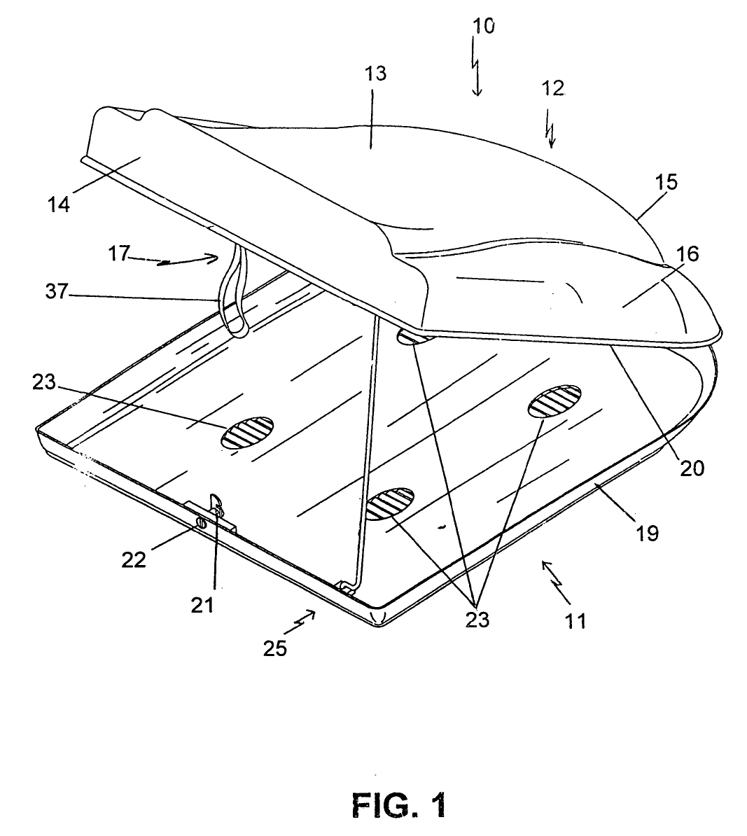

Referring to FIG. 1, which shows the cargo container 10 in an open position, the cargo container 10 is comprised of a lower section 11 hingedly connected to a lid section 12. The lid section 12, which is generally rectangular in shape, is comprised of a container top wall 13, front wall 14, back wall 15, two side walls 16, with an open bottom. The lower section 11, which is also generally rectangular in shape, is comprised of a planar bottom wall 18 with a container lip 19 extending generally outwardly and upwardly from the perimeter of the bottom wall 18. The lid section and lower section form an enclosed storage space 17 between them for storing various items.

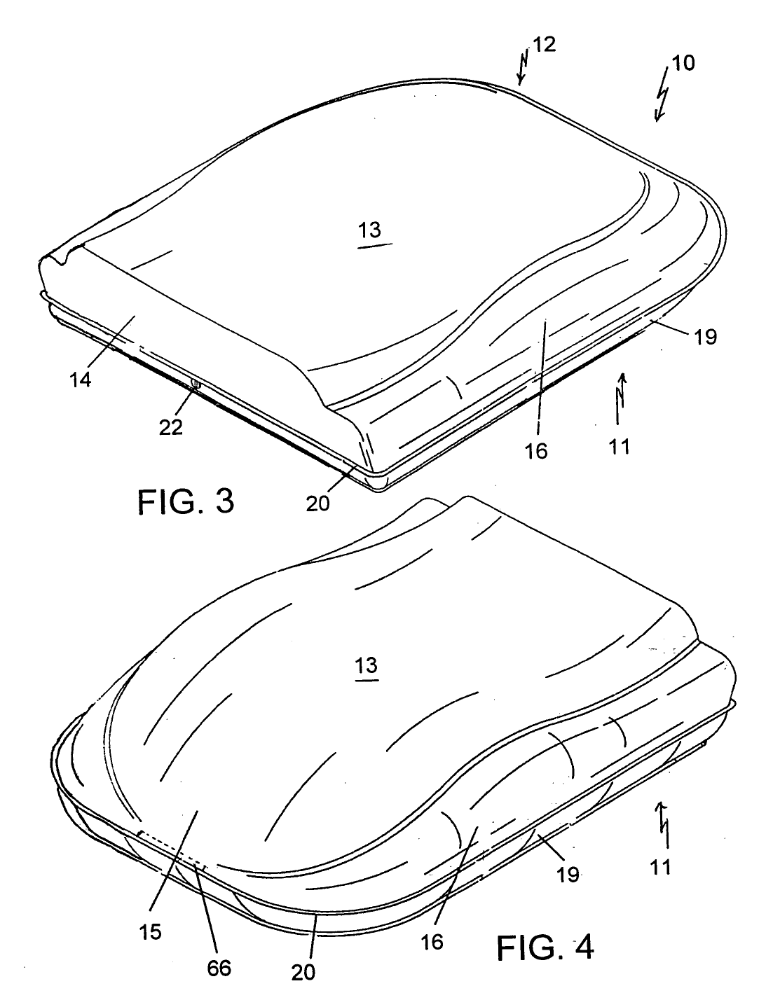

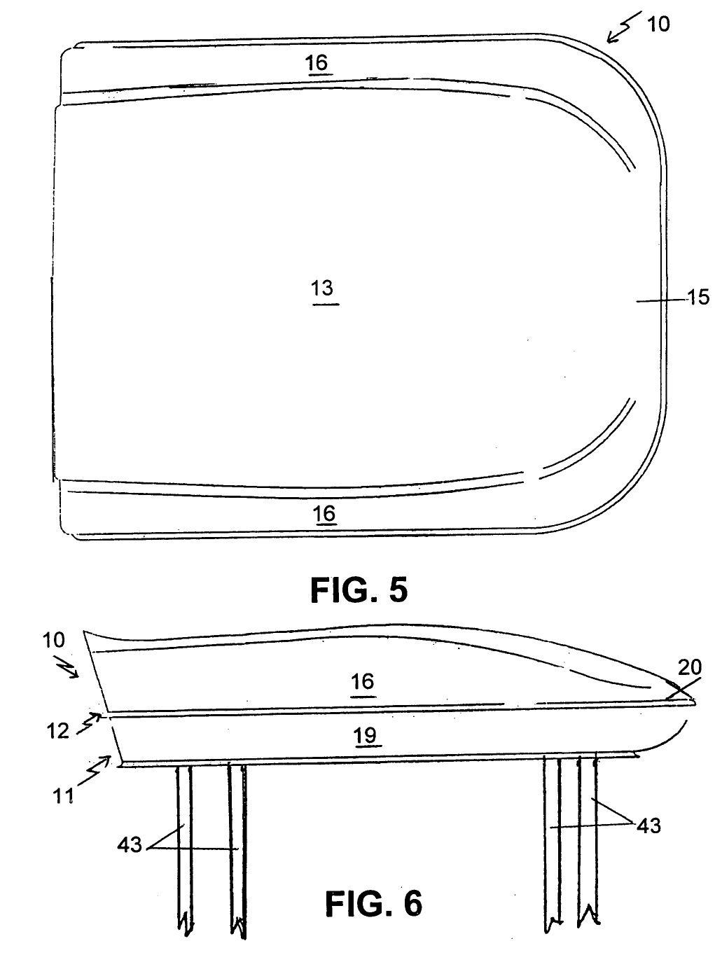

Referring to FIGS. 3 through 6, the lid section 12 is aerodynamic in that it assists in channeling air over the top of the cargo container 10 on a moving watercraft, golf cart, all-terrain vehicle, or the like. The container front wall 14 is substantially vertical but angles slightly outward from the open bottom. The container back wall 15 gently slopes upward from the open bottom to meet the container top wall 13, while the container side walls 16 rise substantially vertically from the open bottom and then curve substantially horizontally to meet the container top wall 13, as seen in FIGS. 3 and 4. The container top wall 13 continues the back wall's upward slope until approximately the mid-point of the cargo container 10, where it levels off. The container top wall 13 also slopes gently upward from the horizontally oriented portions of the side walls 16 for a short distance before leveling off. Before meeting the container front wall 14, the level portion of the container top wall 13 slants generally upwardly. At least one hinge 66 pivotally joins the container back wall 15 and the portion of the container lip 19 below the container back wall 15 for opening and closing the cargo container 10 in a clam shell-like manner.

As shown in FIG. 6, a sealing means 20, such as a rubber gasket, affixed to the edges of the front wall 14, rear wall 15, and side walls 16 adjacent to the open bottom forms a waterproof seal between the lid section 12 and the lower section 111 to prevent rainwater from entering the cargo container 10. The cargo container 10 is shown affixed to roof support struts 43 of a golf cart. The cargo container 10, 40 preferably extends beyond the periphery of the golf cart, so that the cargo container 10, 40 effectively shields occupants of the golf cart from sunshine and rain. When the golf cart or boat is in motion, the narrow end of the aerodynamically shaped cargo container proceeds first into the wind, so that air flow is not disturbed.

Referring back to FIG. 1, a latching mechanism 21, preferably a spring-type latch, protruding from the container lip 19 immediately below the mid-point of the front wall 14 secures the lid section 12 to the lower section 11 when the cargo container 10 is in the closed position. An opening (not shown) in the edge of the container front wall 14 at its mid-point receives the spring-type latch 21 when the cargo container 10 is in the closed position. Preferably, a locking mechanism 22 incorporated into the latching mechanism 21 permits a user to lock and unlock the cargo container 10 so a user may lock valuable items, such as expensive golf clubs, within the cargo container 10. The locking mechanism 22 may be a key-type lock or a combination lock. As well as being a safety feature, the latching mechanism 21 prevents accidental spillage of the contents of the cargo container 10 while the vehicle to which it is attached is in motion.

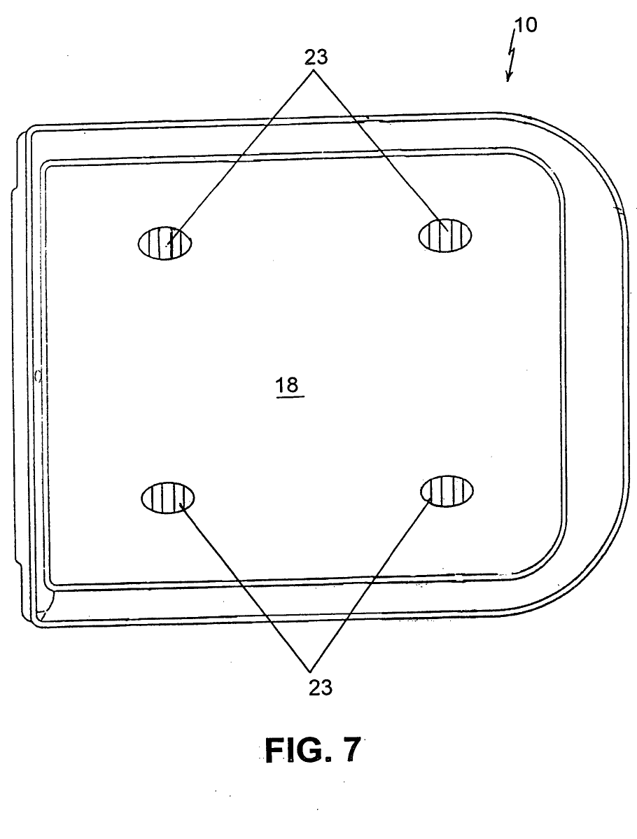

Continuing with FIG. 1 and also referring to FIG. 7, two or more louvered vents 23 in the container bottom wall 18 permit circulation of air between the outside and inside of the cargo container 10. Half of the vents are for air intake and half are for outflowing air. Four vents are preferred. The louvered vents 23 help to prevent moisture build-up within the cargo container 10 and therefore inhibit the growth of mold and mildew within the cargo container 10. The cargo container 10 moves along with the vehicle or watercraft to which it is attached, which encourages air flow through the vents 23.

When the cargo container 10 is in a closed position, as illustrated in FIG. 3, the latching mechanism 21 engages the lid section 12 with the lower section 11, forming a cavity between the lid section 12 and the lower section 11. To open the cargo container 10, the user first unlocks the locking mechanism 22, which dislodges the latching mechanism 21 from the corresponding opening (not shown). Preferably the hinge 66 joining the lid section 12 to the lower section 11 is a spring-loaded hinge, so the lid section 12 automatically rises slightly above the lower section 11 when the latching mechanism 21 is dislodged. Then the user pushes the lid section 12 upward until the cargo container 10 is fully open, and positions a rod assembly 25 to hold the cargo container 10 in the open position, as depicted in FIG. 1. The rod assembly 25 frees the hands of the user to perform other tasks.

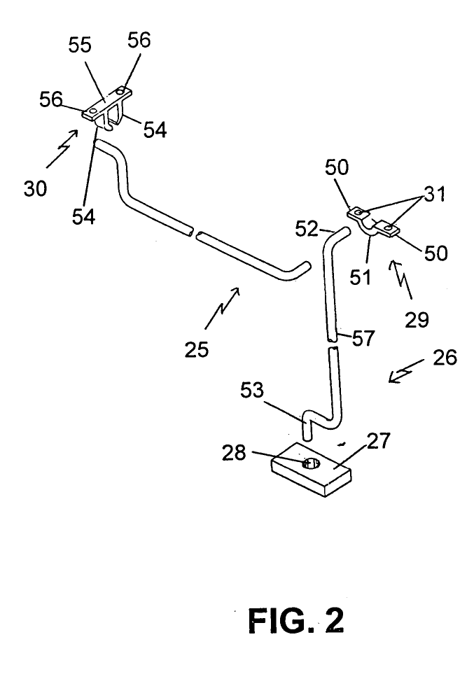

As shown in FIG. 2, the rod assembly 25 is comprised of a rod 26, a base 27, a first bracket 29, and a second bracket 30. The rod 26 pivots approximately 90 degrees from a substantially vertical position to a substantially horizontal position on the first bracket 29, which is mounted on the underside of the container top wall 13 adjacent to the container front wall 14 and to the right of the latching mechanism 21. The first bracket 29 is comprised of two identical first bracket arms 50 projecting from a semi-circular first bracket sleeve 51, which surrounds an upper end 52 of the rod 26. Preferably, bolts (not shown) extending through holes (not shown) in the container top wall 13 and first bracket bolt apertures 31 in the first bracket arms 50, and nuts (not shown) threaded on the bolts, secure the first bracket 29 to the underside of the container top wall 13, and sandwich the upper end 52 of the rod 26 between the first bracket sleeve 51 and the container top wall 13.

In use, to hold the cargo container 10 in the open position, the user pivots the rod 26 to the generally vertical position, shown in FIG. 2, and inserts a lower end 53 of the rod 26 into a generally circular, base aperture 28 in the base 27. Preferably the base 27 is generally rectangular in shape and mounted to the container bottom wall 18 below the first bracket 29. To store the rod 26 so that the user may close the cargo container 10, the user pushes the lid section 12 slightly upward so that the lower end 53 of the rod 26 exits the base aperture 28. Then the user pivots the rod 26 to the alternate, generally horizontal position, which is also shown in FIG. 2, and inserts the lower end 53 of the rod 26 between second bracket arms 54 of the second bracket 30. The second bracket 30 is mounted on the underside of the container top wall 13 adjacent to the container front wall 14 and to the left of the latching mechanism 21.

The second bracket 30 is comprised of spaced apart, mirror image second bracket arms 54, which project generally downwardly from a second bracket attachment base 55. The flexible second bracket arms 54 curve toward each other, so the user may snap the lower end 53 of the rod 26 between the bracket arms 54 to retain it between the arms 54. Preferably, bolts (not shown) extending through holes (not shown) in the container top wall 13 and second bracket bolt apertures 56 in the second bracket arms 56, and nuts (not shown) threaded on the bolts, secure the second bracket 30 to the underside of the top wall 13.

Preferably, the rod 26 further comprises a central portion 57 spanning the distance between its upper end 52 and its lower end 53. The rod upper end 32 is substantially perpendicularly oriented to the central portion 57. The rod lower end 53 is L-shaped and also substantially perpendicularly oriented to the central portion 57. The rod assembly 25 is preferably made of marine grade metal to prevent rusting. The rod assembly 25 is most preferably made of nonrusting stainless steel or fiberglass.

To close the cargo container 10, the user stores the rod 26 as previously described. Next, the user grabs a handle 37, which is attached to the container front wall 14, and pulls the handle 37 in a generally downward direction so that the lid section 12 moves toward the lower section 11. The user continues to pull the handle 37 in a generally downward direction until the latching mechanism 21 engages the lid section 12, with the lower section 11 retaining the cargo container 10 in the closed position, as shown in FIG. 3. The handle 37 preferably hangs down from the lid section 12 so that the user can reach it more easily.

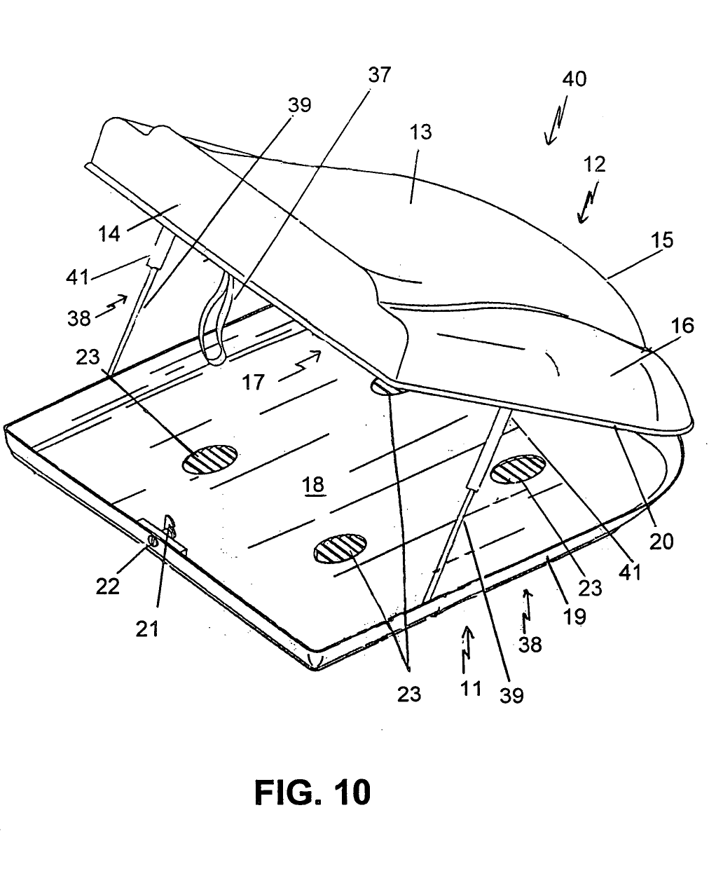

In the alternate embodiment of the cargo container 40 depicted in FIG. 10, the rod assembly 25 is replaced by a pair of gas shocks 38. The first gas shock 38 unites one container side wall 16 and the lip 19 below it, while the second gas shock 38 unites the opposite side wall 16 and the lip 19 below it. Each gas shock 38 includes a piston 39, which moves in and out of a gas-filled cylinder 41.

In use, when the latching mechanism 21 disengages its corresponding opening (not shown), the lid section 12 detaches from the lower section 11. After the lid section 12 detaches from the lower section 11, the gas shocks 38 push the lid section 12 in a generally upward direction away from the lower section 11, until the cargo container 40 is in the open position, as shown in FIG. 10. After the cargo container 40 is open, the gas shocks 38 continue to hold the lid section 12 in place above the lower section 11, so that the user may access the cavity within the cargo container 40.

Ordinarily, a number of tubes 36, which are usually aluminum, form a tubular frame at the top of a watercraft's tee tower. The aluminum tubing 36 may be linear and/or curved. Often, a fabric cover, usually a canvas cover, is stretched over and secured to this tubular frame. This generally horizontal cover is called a tee top. The cargo container 10, 40 of the present invention preferably replaces a fabric tee top, although it can be bolted to a hard cover tee top.

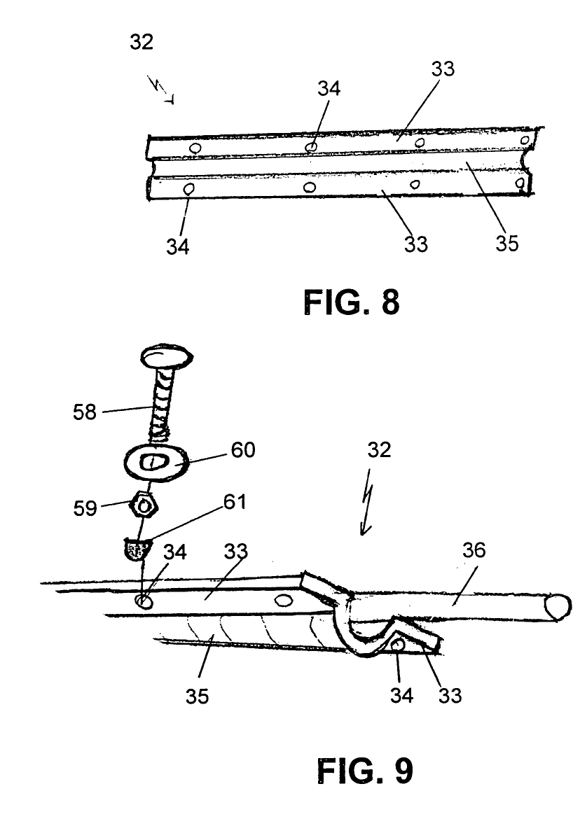

When the cargo container 10, 40 is attached to a tee tower of a watercraft, the underside of the container bottom wall 18 contacts the aluminum tubing 36. The underside of the container bottom wall 18 is secured to the tubular frame by a number of linear attachment devices 32. Referring to FIGS. 8 and 9, which show an attachment device 32 for attachment of the cargo container 10, 40 to a tee tower of a small watercraft, each attachment device 32 has two identical, planar arms 33 protruding from opposite sides of a downwardly projecting attachment sleeve 35. The attachment sleeve 35 is semi-circular in shape. A number of spaced apart, generally circular holes 34 extend transversely through the arms 33 of the sleeve 35. Bolts 58 driven through holes (not shown) in the bottom wall 18 of the cargo container 10, 40 and holes 34 in the attachment device 32 sandwich the linear aluminum tube 36 between the attachment sleeve 35 and the container bottom wall 18. Lock nuts 59 threaded over the bolts 58 secure the attachment device 32 to the linear aluminum tube 36. Preferably, washers 60 are threaded over the bolts between the attachment device 32 and the container bottom wall 18. Bolt caps 61 inserted on the ends of the bolts 58 make the attachment devices 32 more aesthetically appealing. The attachment devices 32, bolts 58, washers 60, and bolt caps 61 are preferably made of marine grade metal to prevent rusting. They are most preferably made of stainless steel. The linear aluminum tubing 36 is encircled between attachment sleeves 35 and the container bottom wall 18 to secure the cargo container 10, 40 to the top of the tee tower.

Foam rubber (not shown) or the like preferably surrounds the aluminum tubing 36 to protect the finish of the bottom wall 18 of the cargo container 10. The foam rubber also prevents squeaking while the watercraft is in motion. Covering the aluminum tubing 36 with foam rubber also enables the attachment device 32 to accommodate aluminum tubes 36 with close diameters.

Golf carts usually have elevated roof support struts 43 (e.g., metal bars) extending transversely across the golf cart. If a particular golf cart does not have a roof or top and roof support struts 43, an owner can purchase roof support struts 43 and easily install them on the golf cart. The cargo container can be attached to the roof struts 43.

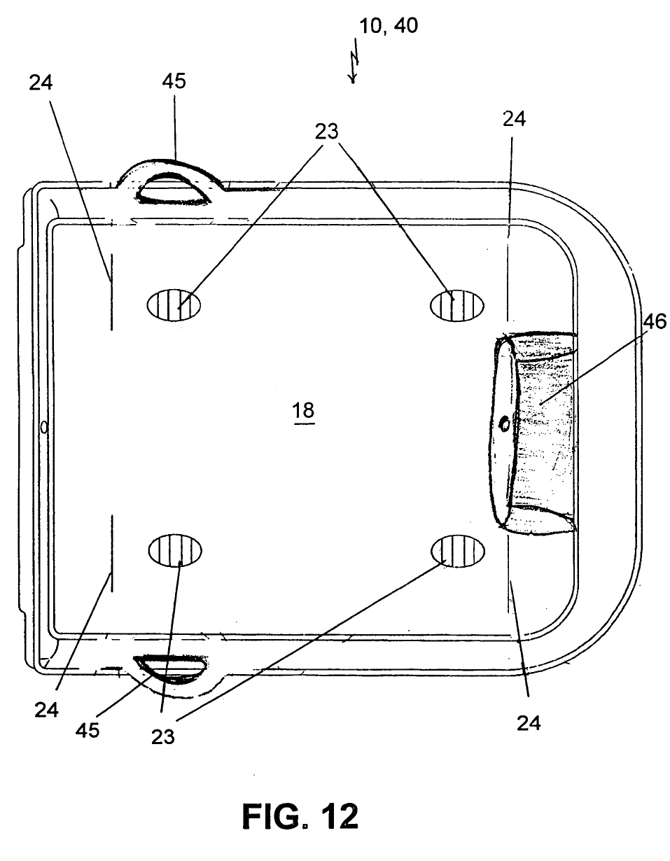

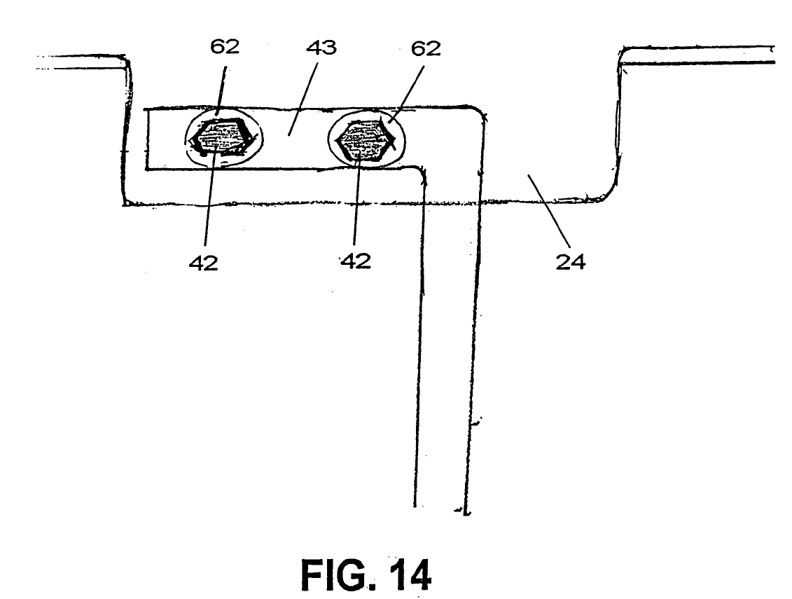

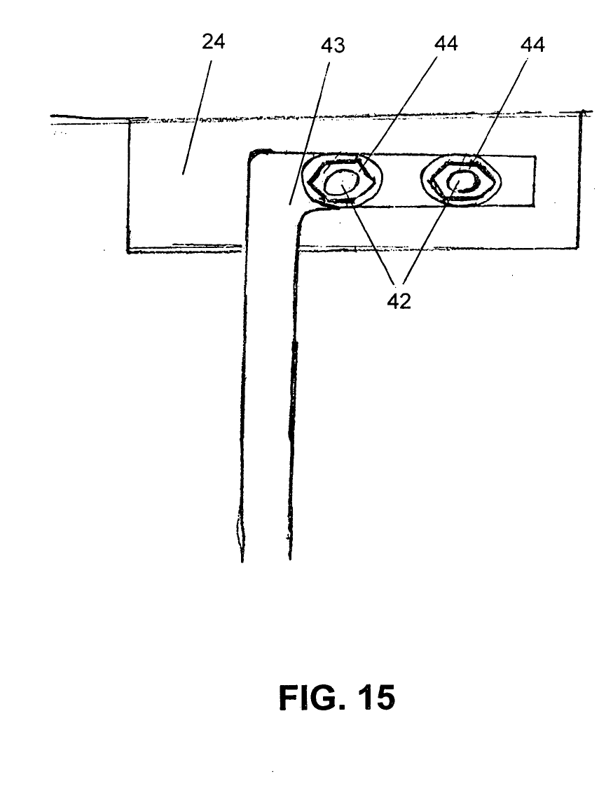

Referring to FIGS. 12, 14, and 15, in an embodiment of the cargo container for attachment to the top of a golf cart or the like in place of a roof or top, four flanges 24 extend generally vertically down from the underside of the container bottom wall 18. The flanges 24, which are preferably generally rectangular in shape, are located near the corners of the container bottom wall 18. Golf cart roof support struts 43, which are oriented substantially parallel to the flanges 24, abut the flanges 24. Flange bolts 42 extending through holes (not shown) in the roof support struts 43 and holes (not shown) in the flanges 24, and flange nuts 44 threaded on the flange bolts 42, secure the cargo carrier 10, 40 to the golf cart. Flange washers 62 are preferably threaded on the flange bolts 42 between the heads of the flange bolts 42 and the flanges 24, and between the flanges 24 and the flange nuts 44.

The flange bolts 42, flange nuts 44, and flange washers 62 are preferably made of marine grade metal to prevent rusting. They are most preferably made of stainless steel.

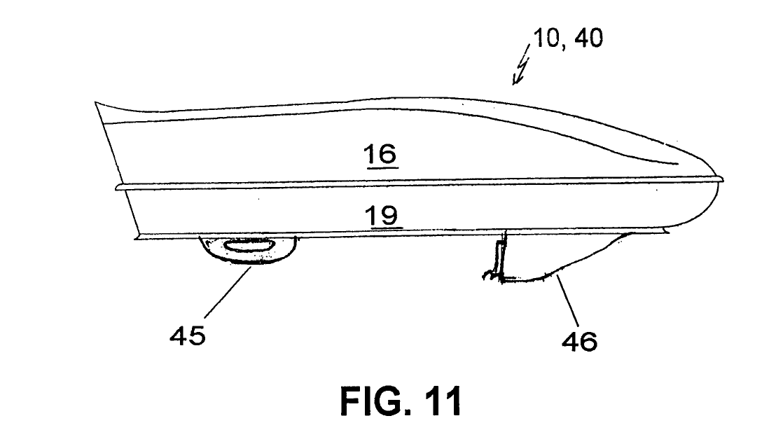

Turning to the cargo container embodiment for attachment to a golf cart or the like in place of a roof or top, which is depicted in FIGS. 11 and 12, two matching hand grips 45 extend in a generally downward direction from the lip 19. A first one of the hand grips 45 projects from a portion of the lip 19 below one container side wall 16, and a second one of the hand grips 45 projects from a portion of the lip 19 below the opposite side wall 16. In use, the user grasps the hand grips 45 to pull himself or herself from a sitting position in the golf cart to a standing position next to the golf cart, all-terrain vehicle, etc. The hand grips 45 are especially useful for elderly users who have difficulty getting up from a seat. A user may also hold onto one of the hand grips 45 to steady himself/herself while the golf cart is in motion. The hand grips 45 are especially useful if the golf cart is traveling over uneven terrain.

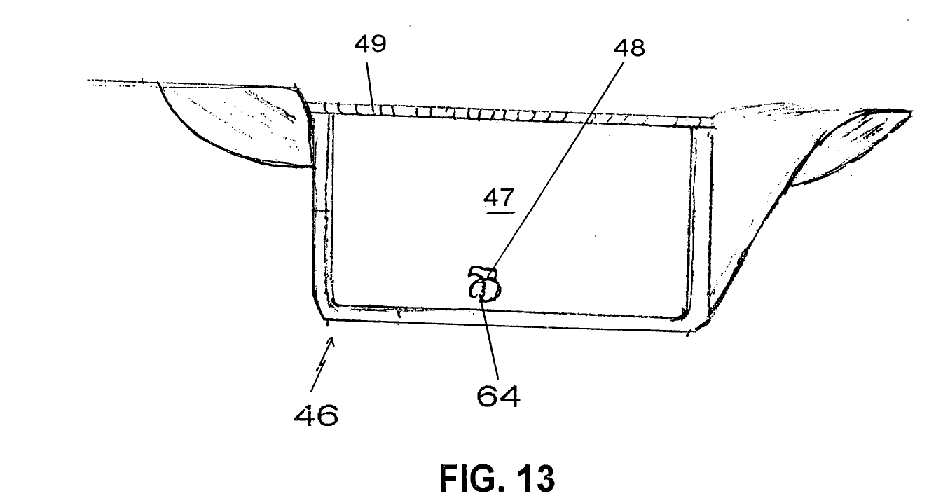

As is also shown in FIGS. 11 and 12, a lower compartment 46 is preferably attached to the underside of the container bottom wall 18 at the mid-point of its rear edge, so the lower compartment 46 is readily accessible to the driver or the front seat passenger. As seen in FIG. 13 the lower compartment 46, which is generally rectangular in shape, may include a door 47 with a door handle 48. The lower compartment door 47 faces the interior of the golf cart for easy access to the interior of the lower compartment 46. The lower compartment door 47 is preferably pivotable about a door hinge 49 connecting the top of the lower compartment door 47 to the bottom wall 18 of the cargo container 10, 40. The lower compartment door 47 also preferably includes a lower compartment locking mechanism 64 for protecting valuable items stored within the lower compartment 46 from theft. The lower compartment locking mechanism 64 may include a key-type lock or a combination lock. Optionally, a user may access the cargo container through an open roof of the lower compartment 46. This is advantageous for removing small items from a front location in the cargo container when the golf cart or boat is underway. The user can reach through the lower compartment door 47 and extract the desired item, rather than having to climb up and fully open the cargo container while the golf cart or boat is in motion.

Continuing to refer to FIGS. 11 through 13, the lower compartment 46 may house electronic equipment powered by batteries or the golf cart's electrical system, such as a weather radio, a satellite radio, a compact disc player, a MP3 player, a television, GPS (global positioning satellite) system, speakers, or a flip-down LED (light emitting diode) screen in communication with an onboard computer. The door 47 of the lower compartment 46 is preferably made from a transparent material for viewing the electronic equipment, especially a television, a global positioning satellite system, or a flip-down LED screen, through the door. Where the cargo container 10, 40 is in use on a watercraft, it may be used to store electronic equipment within the interior of the cargo container.

The cargo container 10, 40 may further comprise interior lights for illuminating the watercraft, golf cart, all-terrain vehicle, or the like at night. Additionally, the cargo container 10, 40 may include a rack attached to the top wall 13 of the lid section 12 for hauling oversize items, such as surfboards, boogie boards, bicycles, or fishing poles. The cargo container 10, 40 for attachment to the top of a golf cart or the like may further comprise a set of headlights on the back wall 15 of the lid section 12, and/or brake lights and turn signals with hazard lights on the front wall 14 of the lid section 12.

The cargo container 10, 40 is preferably made of a lightweight material, such as ultraviolet light (UV) resistant A.B.S. fiberglass or polyethylene. The cargo container 10, 40 can be any color, including custom colors. The cargo container 10, 40 may also have a padded interior to protect and cushion cargo.

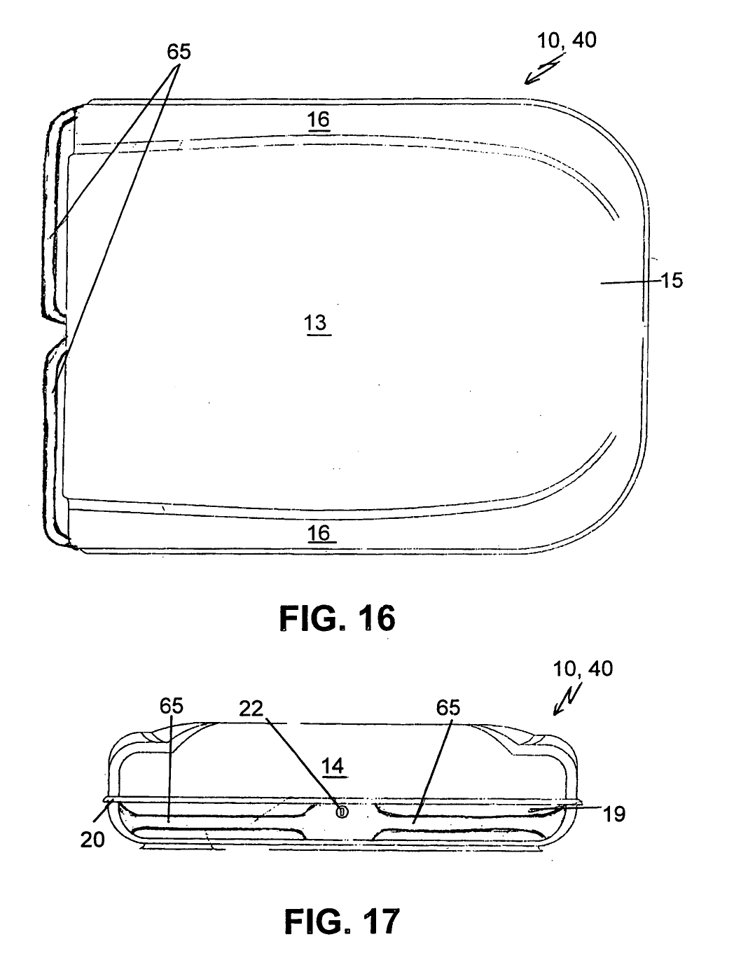

Referring to FIGS. 16 and 17, the first handle 65 may alternatively include a pair of same-sized grips, with a first one located to the right of the locking mechanism 22 and a second one to the left of the locking mechanism 22. In this case, the first handle 65 projects outwardly from the lip 19 in a generally horizontal plane.

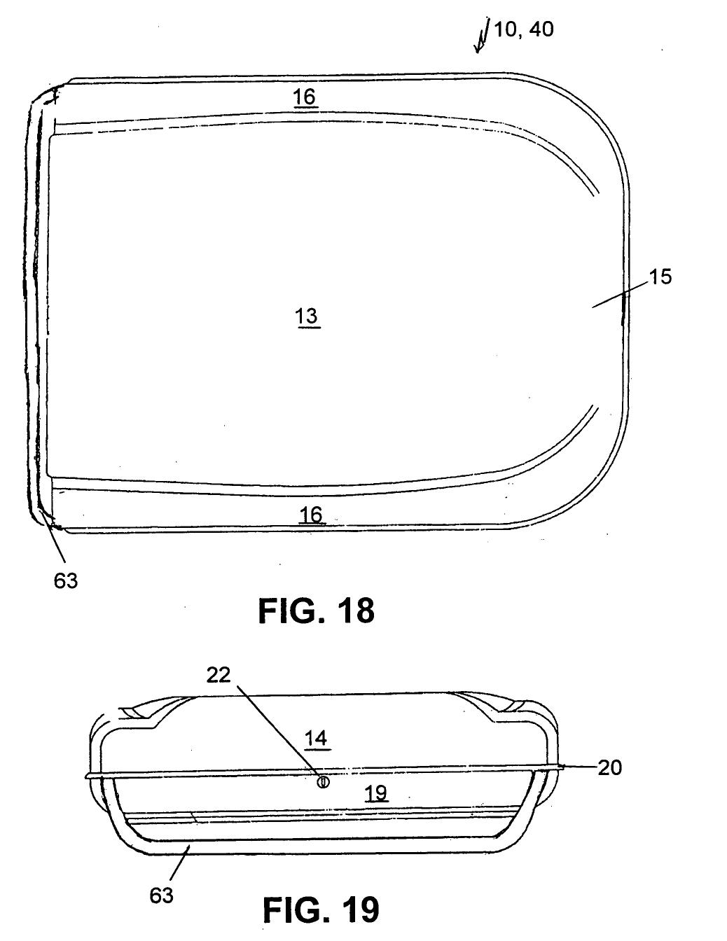

Referring to FIGS. 18 and 19, in a preferred embodiment of the cargo container 10, 40, opposite ends of a second, elongate handle 63 are affixed to the lip 19 directly below the container front wall 14. Here, the elongate handle 63 projects generally outwardly and downwardly from the lip 19 for the entire width of the cargo container 10, 40, as shown in FIGS. 18 and 19. In use, the user may utilize the elongate handle 63 to support and steady himself or herself when retrieving items from and packing items into the cargo container 10, 40. This is particularly desirable when the watercraft is wet and pitching, or a user who is short in stature is precariously balanced on a rear step of a golf cart reaching up into the cargo container.

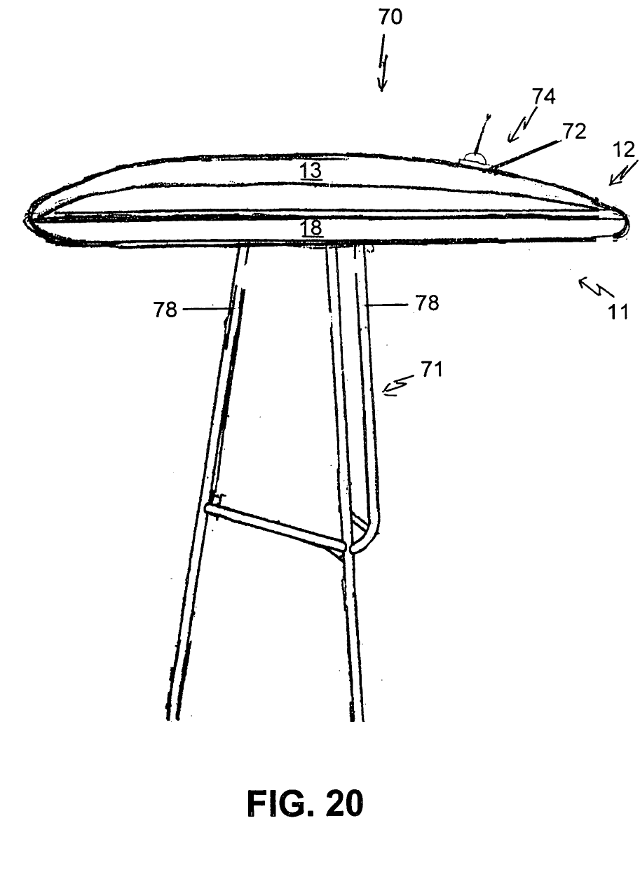

Turning to FIG. 20, an alternate, generally clam shell-shaped embodiment of a cargo container 70, which includes a lid section 12 fitted to a corresponding lower section 11, is attached to a top of a tee tower 71 of a watercraft. This container shape has been found to be balanced and aerodynamic, yet suitable for storage. This is an important characteristic for a cargo container mounted on top of a small watercraft moving through the water at an even clip. An imbalanced, heavy, bulky cargo container would impede forward motion of the watercraft, and has the potential to upset the watercraft, as well as the user.

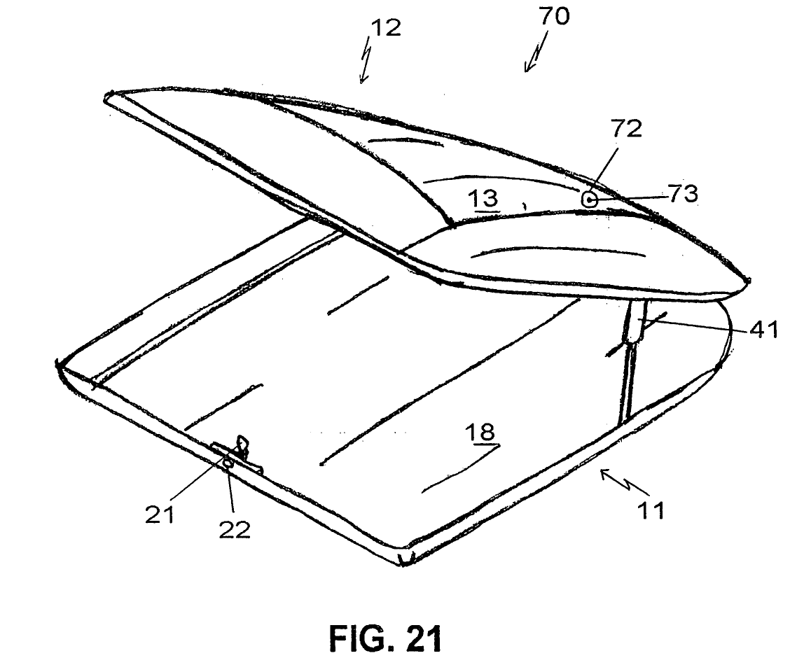

Referring to FIGS. 20 and 21, whether it is mounted on a tee tower 71, or a top of a golf cart or the like, the cargo container 10, 40, 70 optionally comprises a circular indentation 72 with a mounting mechanism 73 for mounting a radio antenna 74 or the like in its top wall 13. As shown in FIG. 21, the mounting mechanism is preferably a hole at the center of a circular indentation 72 in the top wall of the cargo container through which a lower portion of the antenna device is inserted and fastened. The lower section 11 of the cargo container 70 includes a latching mechanism 21 and a locking mechanism 22, as seen in FIG. 21. The preferred embodiment depicted in FIG. 21 includes an air-driven piston 41 on each side of the cargo container to facilitate opening of the lid section.

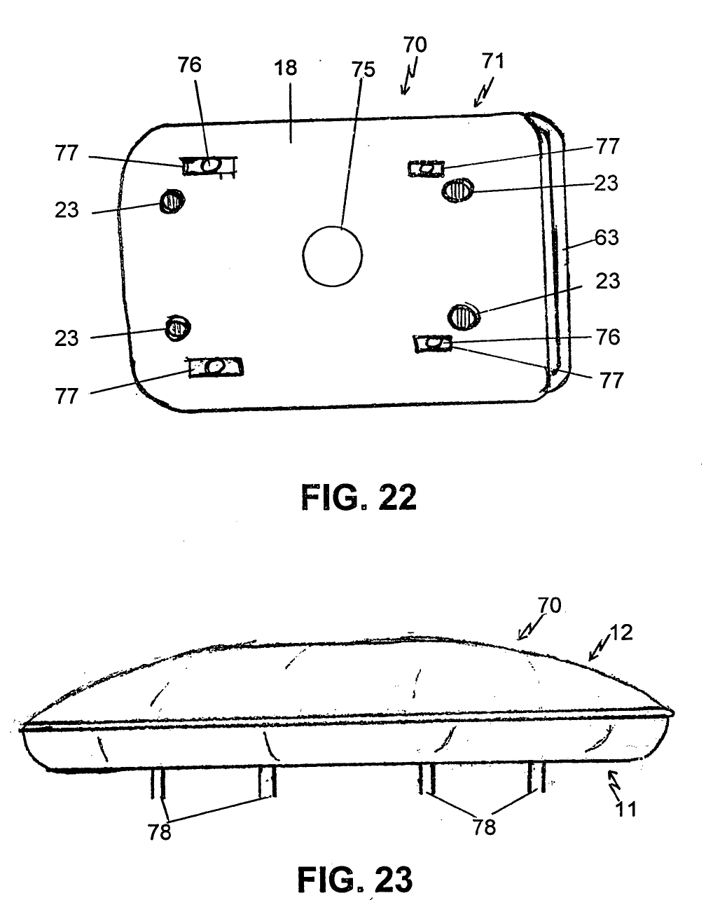

Since tee tops and tee towers vary widely, the means of attaching the cargo container 70 to the tee top or tee tower also vary, depending on the type of tee tower and its tubing, and on whether the tee top cover will or will not be removed prior to installation of the cargo container. Referring to FIGS. 22 and 23, a preferred embodiment for attachment to a tee tower comprises four tube apertures 76 for receiving the upper ends of same-sized aluminum tubes 78 of the tee tower. The ends of the tubes 78 are bolted to tube attachment plates 77 inside the container bottom wall 18. The number and size of the tube apertures 76 may vary depending on the number and diameter of aluminum tubes 78 in the tee tower 71. When they sit or stand under it, the cargo container 70 also serves to shield occupants of the boat from sunshine and rain.

This embodiment includes four louvered vents 23 for promoting air circulation within the cargo container to protect against mold and mildew and other damage. As shown in FIG. 22, this preferred embodiment also includes an elongate handle 63 for the user to grasp and stabilize himself or herself, and then to pull up or down while opening or closing the lid section 12 of the cargo container. The cargo container 70 may further comprise an exterior dome light 75 attached to the bottom wall 18 for illuminating the watercraft (or golf cart or all-terrain vehicle) at night.

From the foregoing it can be realized that the described device of the present invention may be easily and conveniently utilized as a cargo container for a golf cart, a utility vehicle, an all terrain vehicle, or a watercraft with a tee tower. It is to be understood that any dimensions given herein are illustrative, and are not meant to be limiting.

While preferred embodiments of the invention have been described using specific terms, this description is for illustrative purposes only. It will be apparent to those of ordinary skill in the art that various modifications, substitutions, omissions, and changes may be made without departing from the spirit or scope of the invention, and that such are intended to be within the scope of the present invention as defined by the following claims. It is intended that the doctrine of equivalents be relied upon to determine the fair scope of these claims in connection with any other person's product which fall outside the literal wording of these claims, but which in reality do not materially depart from this invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

### BRIEF LIST OF REFERENCE NUMBERS USED IN THE DRAWINGS

10 cargo container
11 lower section
12 lid section
13 top wall
14 front wall
15 back wall
16 side wall
17 storage space
18 bottom wall
19 lip
20 sealing means
21 latching mechanism
22 locking mechanism
23 vent
24 flange
25 rod assembly
26 rod
27 base
28 base aperture
29 first bracket
30 second bracket
31 first bracket bolt apertures
32 device
33 arm
34 hole
35 sleeve
36 aluminum tubing
37 handle
38 gas shock
39 piston
40 alternative embodiment of cargo container
41 gas-filled cylinder
42 flange bolt
43 roof support strut
44 flange nut
45 first grip
46 lower compartment
47 lower compartment door
48 lower compartment door handle
49 lower compartment door hinge
50 first bracket arms
51 first bracket sleeve
52 upper end
53 lower end
54 second bracket arms
55 second bracket attachment base
56 second bracket bolt aperture
57 central portion
58 bolt
59 lock nut
60 washer
61 bolt cap
62 flange washer
63 elongate handle
64 lower compartment locking mechanism
65 first handle
66 container hinge
70 alternate embodiment of cargo container
71 tee tower
72 circular indentation
73 antenna mounting mechanism
74 antenna
75 exterior dome light
76 tube apertures
77 tube plates
78 aluminum tee tower tubes

1. A cargo container attachable to a top of a tee tower of a watercraft, a golf cart, or an all-terrain vehicle, the cargo container comprising:
(a) an upper lid section;
(b) a lower section pivotally connected to the lid section, the lower section comprising a bottom wall and a lip extending generally upwardly from a periphery of the bottom wall;
(c) a storage space formed by the upper lid section and the lower section;
(d) at least one hinge pivotally connecting the lid section and the lower section; and
(e) an attachment mechanism on the bottom wall of the lower section for securing the cargo container to the tee tower, golf cart, or all-terrain vehicle.

2. The cargo container according to claim 1, further comprising a lower compartment on the bottom wall; wherein the cargo container is accessible through the lower compartment from an underside of the cargo container.

3. The cargo container according to claim 1, wherein the lid section is generally rectangular in shape, the lid section comprising:
(a) a top wall;
(b) a front wall oriented generally perpendicularly to the top wall;
(c) an open bottom oriented generally perpendicularly to the front wall;
(d) a back wall oriented generally perpendicularly to the open bottom and generally parallel to the top wall; and
(e) two matching side walls oriented generally perpendicularly to the open bottom and generally parallel to the top wall;
wherein the back wall slopes gradually upward from the open bottom to meet the top wall, the side walls rise substantially vertically from the open bottom and curve substantially horizontally to meet the top wall, and the top wall slopes gradually upward from the back wall and the side walls and levels off in a horizontal plane.

4. The cargo container according to claim 1, further comprising a rod assembly, the rod assembly comprising:
(a) a first bracket attached to an underside of the top wall adjacent to the front wall;
(b) a base attached to a top side of the bottom wall;
(c) a base aperture extending through the base;
(d) a second bracket attached to the underside of the top wall adjacent to the front wall; and
(e) a rod having an upper end pivotable about the first bracket and an opposite, lower end removably insertable in the base aperture and removably securable to the second bracket.

5. The cargo container according to claim 3, wherein the bottom wall comprises at least two louvered vents.

6. The cargo container according to claim 4, further comprising a latching mechanism attached to the lip below the front wall for latching the lid section to the lower section.

7. The cargo container according to claim 6, wherein the latching mechanism comprises a locking mechanism for locking the cargo container.

8. The cargo container according to claim 3, wherein the lid section comprises an elongate handle attached to the front wall, the elongate handle extending across a width of the cargo container and extending in a downward direction below the bottom wall of the lower section.

9. The cargo container according to claim 8, further comprising two pistons, each one of the pistons extending between the lid section and the lower section on a side of the container.

10. The cargo container according to claim 3, further comprising a lower compartment extending generally downwardly from the bottom wall and adjacent to the back wall or front wall.

11. The cargo container according to claim 10, further comprising at least two hand grips, each extending generally downwardly from the bottom wall and adjacent to a portion of the lip below an opposite side wall.

12. The cargo container according to claim 3, further comprising at least one handle appended to a portion of the lip below the front wall.

13. The cargo container according to claim 12, the lower compartment comprising:
(a) a lower compartment door pivotally connected to the bottom wall;
(b) a door hinge pivotally connecting the bottom wall and the lower compartment door; and
(c) a lower compartment locking mechanism incorporated into the lower compartment door.

14. The cargo container according to claim 4, wherein the at least one hinge is a spring-loaded hinge.

15. The cargo container according to claim 1, wherein the attachment mechanism comprises two matching, planar arms, a sleeve projecting generally downwardly between the arms for accommodating an aluminum tube of the tee tower, golf cart, or all-terrain vehicle, and a plurality of spaced-apart holes extending through the arms.

16. The cargo container according to claim 1, wherein the attachment mechanism comprises at least two spaced-apart tube apertures in the bottom wall for receiving the upper ends of aluminum tubes of the tee tower, and a like number of tube attachment plates for receiving the ends of the tubes, each tube attachment plate being adjacent a tube aperture inside the bottom wall.

17. A cargo container attachable to roof support struts of a golf cart, a utility cart, or an all-terrain vehicle, the cargo container comprising:
(a) a lid section;
(b) a lower section pivotally connected to the lid section, the lower section comprising a bottom wall and a lip extending generally upwardly from a periphery of the bottom wall;
(c) a storage space formed by the upper lid section and the lower section;
(d) at least one hinge pivotally connecting the lid section and the lower section; and
(e) a plurality of flanges extending generally downwardly from the lower section for securing the lower section to the roof support struts.

18. The cargo container according to claim 17, further comprising a plurality of flange bolts insertable through the flanges, and a plurality of flange nuts threadable on the flange bolts.

19. The cargo container according to claim 17, wherein the lid section comprises a first handle attached to the lower section.
